(19) United States
(12) Patent Application Publication
(10) Pub. No.: US 2024/0067784 A1
(43) Pub. Date: Feb. 29, 2024

(54) POLYESTER-BASED FILM, MANUFACTURING METHOD THEREFOR, AND MEMBRANE ELECTRODE ASSEMBLY COMPRISING SAME

(71) Applicant: SKC CO., LTD., Gyeonggi-do (KR)

(72) Inventors: Young Min HEO, Gyeonggi-do (KR); Byeong Jae LIM, Gyeonggi-do (KR); Jewon YEON, Gyeonggi-do (KR); Ki Youn SONG, Gyeonggi-do (KR)

(21) Appl. No.: 18/260,039

(22) PCT Filed: Dec. 17, 2021
(86) PCT No.: PCT/KR2021/019301

§ 371 Date: Jun. 30, 2023

(30) Foreign Application Priority Data
Jan. 26, 2021 (KR) 10-2021-0010962

(51) Int. Cl. C08J 5/18; B29C 48/00; B29C 48/08; B29C 48/78; H01M 8/1004

(52) U.S. Cl. CPC C08J 5/18; B29C 48/0018; B29C 48/08; B29C 48/78; H01M 8/1004; B29K 2067/00; C08J 2367/02

(57) ABSTRACT

An implementation relates to a polyester-based film having low hygroscopicity, a manufacturing method therefor, and a membrane electrode assembly comprising same, and the polyester-based film has excellent flexibility, adhesion and durability and has a moisture absorption represented by formula 1, which meets 0.25% or less, and thus has excellent hydrolysis resistance so as to be applied as a film for a fuel cell sub-gasket and exhibit excellent characteristics.

### TECHNICAL FIELD

Embodiments relate to a polyester-based film, to a process for preparing the same, and to a membrane electrode assembly comprising the same.

### BACKGROUND ART

A fuel cell is a device that generates electrical energy by electrochemically reacting a fuel and an oxidizing agent. Hydrogen, methanol, butane, and the like may be used as a fuel, and oxygen, air, chlorine, chlorine dioxide, and the like may be used as an oxidizing agent. Such a fuel cell comprises a plurality of unit cells, and the unit cells comprise a membrane electrode assembly (MEA) capable of generating electricity by transporting a fuel or the like.

A membrane electrode assembly may be composed of an electrolyte membrane and electrodes (anode and cathode) disposed on both sides of the electrolyte membrane. The performance of the membrane electrode assembly may be deteriorated due to the hygroscopicity of the electrolyte membrane. Hence, a gasket is used to prevent the electrolyte membrane from being exposed to the outside, as well as to prevent the fuel or the like from leaking out or being mixed with air or the like.

Conventionally, a fluorine- or silicon-based material has been mainly used as a gasket since it is easy to manufacture and has excellent sealing characteristics. However, a fluorine- or silicon-based gasket has a limit in completely blocking the fuel or the like. In addition, fluorine-based gaskets are expensive and have poor moldability. Thus, research on gaskets that can replace fluorine- or silicon-based gaskets and have excellent properties such as durability in terms of thermal resistance and cold resistance and low hygroscopicity is being continued.

As an example, Korean Laid-open Patent Publication No. 2014-0036536 discloses an injection-molded integrated gasket for a hydrogen fuel cell that has increased airtight durability by carrying out direct injection molding on a separator and crosslinking it for the integration thereof.

### PRIOR ART DOCUMENT

### Patent Document

(Patent Document 1) Korean Laid-open Patent Publication No. 2014-0036536

### DISCLOSURE OF INVENTION

### Technical Problem

Accordingly, the embodiments aim to provide a polyester-based film that is excellent in flexibility, adhesion, hydrolysis resistance, and durability, a process for preparing the same, and a membrane electrode assembly comprising the same.

### Solution to Problem

The polyester-based film according to an embodiment comprises a copolymerized polyester-based resin in which a diol and a dicarboxylic acid are copolymerized, wherein the diol comprises cyclohexanedimethanol or a derivative thereof, the dicarboxylic acid comprises 70% by mole to 99% by mole of terephthalic acid and 1% by mole to 30% by mole of isophthalic acid, and the moisture absorption rate according to the following Equation 1 is 0.25% or less.

$$\\ \begin{matrix}Moisture absorption rate = \frac{( B - A )}{A} \times 100 & [ Equation 1 ]\end{matrix}$$

In Equation 1, A is the weight (g) of the film measured after the film is dried in an oven at 50° C. for 24 hours, and B is the weight (g) of the film measured after the dried film under the above conditions is left at a temperature of 25° C. and a humidity of 100% RH for 24 hours.

The process for preparing a polyester-based film according to another embodiment comprises melt-extruding a copolymerized polyester-based resin in which a diol and a dicarboxylic acid are copolymerized to prepare an unstretched sheet; stretching the unstretched sheet 2 to 5 times in a first direction at 70° C. to 100° C. and stretching it 2 to 5 times in a second direction perpendicular to the first direction to prepare a stretched sheet; heat-setting the stretched sheet at 200° C. to 260° C.; and relaxing the heat-set sheet to prepare the polyester-based film, wherein the diol comprises cyclohexanedimethanol or a derivative thereof, the dicarboxylic acid comprises 70% by mole to 99% by mole of terephthalic acid and 1% by mole to 30% by mole of isophthalic acid, and the moisture absorption rate of the polyester-based film according to the above Equation 1 is 0.25% or less.

The membrane electrode assembly according to still another embodiment comprises an electrolyte membrane; and a sub-gasket surrounding the distal ends of one side or both sides of the electrolyte membrane, wherein the sub-gasket comprises a copolymerized polyester-based resin in which a diol and a dicarboxylic acid are copolymerized, the diol comprises cyclohexanedimethanol or a derivative thereof, the dicarboxylic acid comprises 70% by mole to 99% by mole of terephthalic acid and 1% by mole to 30% by mole of isophthalic acid, and the moisture absorption rate according to the above Equation 1 is 0.25% or less.

### Advantageous Effects of Invention

As the polyester-based film according to the embodiment comprises a copolymerized polyester-based resin in which specific components and contents of a diol and a dicarboxylic acid are copolymerized, it has excellent flexibility, adhesion, and durability. In particular, as the polyester-based film satisfies a moisture absorption rate of 0.25% or less according to Equation 1, it has excellent hydrolysis resistance and thus significantly low hygroscopicity.

Accordingly, when the polyester-based film is applied as a film for a sub-gasket of a fuel cell, particularly, a film for a sub-gasket of a hydrogen fuel cell in which low hygroscopicity, high thermal resistance, and high chemical resistance are important, it is possible to effectively prevent deterioration of the fuel cell performance and to enhance its stability and reliability.

### BRIEF DESCRIPTION OF DRAWINGS

FIG. 1 shows an exploded view of a fuel cell.

FIG. 2 shows a perspective view of a membrane electrode assembly according to an embodiment.

FIG. 3 shows a top view of a membrane electrode assembly according to an embodiment.

FIG. 4 is a cross-sectional view of the membrane electrode assembly of FIG. 3 taken along line X-X′.

### EXPLANATION OF REFERENCE NUMERALS

1: fuel cell
10: fuel cell unit cell
100: membrane electrode assembly
200: separator
300: end plate
110: first sub-gasket film
120: second sub-gasket film
130: adhesive layer
140: electrolyte membrane
150: first electrode
160: second electrode

### BEST MODE FOR CARRYING OUT THE INVENTION

Hereinafter, the present invention will be described in detail with reference to embodiments. The embodiments are not limited to those described below. Rather, they can be modified into various forms as long as the gist of the invention is not altered.

Throughout the present specification, when a part is referred to as “comprising” an element, it is understood that other elements may be comprised, rather than other elements are excluded, unless specifically stated otherwise.

All numbers and expressions related to the quantities of components, reaction conditions, and the like used herein are to be understood as being modified by the term “about” unless otherwise indicated.

Throughout the present specification, the terms first, second, and the like are used to describe various components. But the components should not be limited by the terms. The terms are used only for the purpose of distinguishing one component from another.

In the present specification, in the case where each film, layer, or the like is mentioned to be formed “on” or “under” another film, layer, or the like, it means not only that one element is directly formed on or under another element, but also that one element is indirectly formed on or under another element with other element(s) interposed between them.

For the sake of description, the sizes of individual elements in the appended drawings may be exaggeratedly depicted, and they may differ from the actual sizes.

Polyester-Based Film

The polyester-based film according to an embodiment comprises a copolymerized polyester-based resin in which a diol and a dicarboxylic acid are copolymerized, wherein the diol comprises cyclohexanedimethanol or a derivative thereof, the dicarboxylic acid comprises 70% by mole to 99% by mole of terephthalic acid and 1% by mole to 30% by mole of isophthalic acid, and the moisture absorption rate according to the following Equation 1 is 0.25% or less.

$$\\ \begin{matrix}Moisture absorption rate = \frac{( B - A )}{A} \times 100 & [ Equation 1 ]\end{matrix}$$

In Equation 1, A is the weight (g) of the film measured after the film is dried in an oven at 50° C. for 24 hours, and B is the weight (g) of the film measured after the dried film under the above conditions is left at a temperature of 25° C. and a humidity of 100% RH for 24 hours.

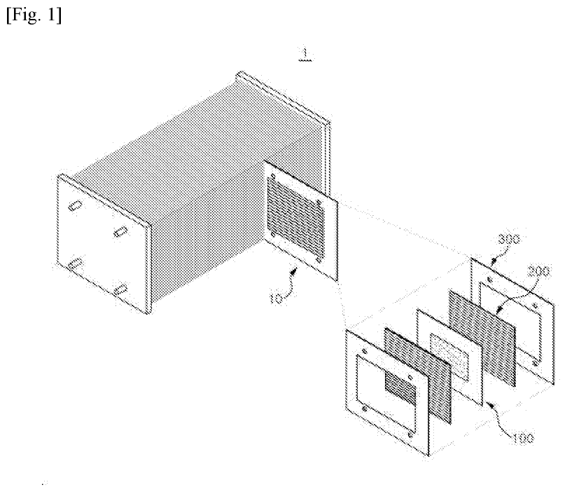

FIG. 1 shows an exploded view of a fuel cell. Specifically, the fuel cell (1) comprises a plurality of fuel cell unit cells (10), and the fuel cell unit cell (10) comprises a membrane electrode assembly (100), a separator (200), and an end plate (300).

A membrane electrode assembly may be composed of an electrolyte membrane and electrodes (anode and cathode) disposed on both sides of the electrolyte membrane. The performance of the membrane electrode assembly may be deteriorated due to the hygroscopicity of the electrolyte membrane.

A gasket used in a fuel cell is to prevent the electrolyte membrane from being exposed to the outside, as well as to prevent the fuel supplied or the like from leaking out or being mixed with air or the like. Conventionally, a fluorine- or silicon-based material has been mainly used as a gasket since it is easy to manufacture and has excellent sealing characteristics. However, a fluorine- or silicon-based gasket has a limit in completely blocking the fuel or the like. Thus, a gasket in the form of a film has been used.

In recent years, a polyethylene naphthalate-based film is used as a gasket film since it has excellent moldability and durability. But it has a limit in the improvement of adhesion and airtightness due to its low flexibility.

Meanwhile, in a hydrogen fuel cell using hydrogen as a fuel and oxygen as an oxidizing agent, particularly, a vehicle using a hydrogen fuel cell, heat is generated while driving and stopping are repeated, which causes frequent contraction and expansion. Thus, not only airtightness but also low hygroscopicity, high durability in terms of thermal resistance and cold resistance, and high chemical resistance are very important in a hydrogen fuel cell system.

As the polyester-based film according to an embodiment comprises a copolymerized polyester-based resin in which specific components and contents of a diol and a dicarboxylic acid are copolymerized, it has excellent flexibility, adhesion, and durability. In particular, as the polyester-based film satisfies a moisture absorption rate of 0.25% or less according to Equation 1, it has excellent hydrolysis resistance and thus significantly low hygroscopicity. Accordingly, when the polyester-based film is applied as a film for a gasket of a hydrogen fuel cell, it is possible to effectively prevent deterioration of the hydrogen fuel cell performance and to enhance its stability and reliability.

The polyester-based film comprises a copolymerized polyester-based resin in which a diol and a dicarboxylic acid are copolymerized.

The diol comprises cyclohexanedimethanol or a derivative thereof. For example, the diol may comprise 1,2-cyclohexanedimethanol, 1,3-cyclohexanedimethanol, or 1,4-cyclohexanedimethanol. Preferably, it may comprise 1,4-cyclohexanedimethanol.

In addition, the diol may comprise cyclohexanedimethanol or a derivative thereof in an amount of 70% by mole or more. For example, the copolymerized polyester-based resin may comprise cyclohexanedimethanol or a derivative thereof in an amount of 72% by mole or more, 75% by mole or more, 85% by mole or more, 88% by mole or more, 90% by mole or more, 93% by mole or more, 95% by mole or more, 97% by mole or more, 99% by mole or more, or 100% by mole, based on the total number of moles of the diol.

If the diol comprises cyclohexanedimethanol or a derivative thereof in the above content range, it is possible to enhance the flexibility, adhesion, durability, and hydrolysis resistance. If the diol is composed of cyclohexanedimethanol alone, it is possible to maximize the thermal resistance and hydrolysis resistance.

In addition, the diol may comprise at least one selected from the group consisting of ethylene glycol, neopentyl glycol, and diethylene glycol, if necessary. For example, the copolymerized polyester-based resin may comprise at least one selected from the group consisting of ethylene glycol, neopentyl glycol, and diethylene glycol in an amount of 1% by mole to 30% by mole, 1% by mole to 20% by mole, 1% by mole to 15% by mole, 1% by mole to 10% by mole, or 1% by mole to 5% by mole, based on the total number of moles of the diol.

The dicarboxylic acid comprises 70% by mole to 99% by mole of terephthalic acid and 1% by mole to 30% by mole of isophthalic acid. For example, the copolymerized polyester-based resin may comprise terephthalic acid in an amount of 72% by mole to 99% by mole, 75% by mole to 99% by mole, 80% by mole to 98% by mole, 83% by mole to 98% by mole, or 85% by mole to 98% by mole and isophthalic acid in an amount of 1% by mole to 28% by mole, 1% by mole to 25% by mole, 1% by mole to 20% by mole, 2% by mole to 15% by mole, or 3% by mole to 13% by mole, based on the total number of moles of the dicarboxylic acid.

If the contents of terephthalic acid and isophthalic acid satisfy the above ranges, it is possible to enhance the flexibility, thermal resistance, and hydrolysis resistance.

In addition, the copolymerized polyester-based resin may further comprise at least one additive selected from the group consisting of ultraviolet stabilizers, thermal stabilizers, antioxidants, and inert particles.

Specifically, the ultraviolet stabilizer may be at least one selected from the group consisting of benzophenone-based, benzotriazole-based, cyanoacrylate-based, and salicylic acid ester-based compounds. The thermal stabilizer may be an iodine-based compound. The antioxidant may be a phosphorus-based antioxidant, a phenol-based antioxidant, or a sulfur-based antioxidant. The inert particles may be silica or potassium carbonate. But they are not limited thereto.

The content of the additive may be 0.5% by weight to 15% by weight, 1% by weight to 13% by weight, 1.2% by weight to 12% by weight, 1.5% by weight to 10% by weight, 1.7% by weight to 8% by weight, or 1.8% by weight to 7.5% by weight, based on the total weight of the copolymerized polyester-based resin.

The polyester-based film according to an embodiment may be a film for a gasket of a fuel cell. Specifically, the polyester-based film may be a film for a sub-gasket of a fuel cell.

The polyester-based film may have a moisture absorption rate according to the above Equation 1 of 0.25% or less. Specifically, the moisture absorption rate according to the above Equation 1 of the polyester-based film may be 0.23% or less, 0.2% or less, 0.18% or less, 0.15% or less, 0.13% or less, or 0.1% or less. If the moisture absorption rate satisfies the above range, the polyester-based film has excellent hydrolysis resistance and thus significantly low hygroscopicity.

In addition, the polyester-based film may have a modulus in a first direction in the plane of the film of 400 kgf/mm² or less and a modulus in a second direction perpendicular to the first direction of 550 kgf/mm² or less.

For example, the modulus in a first direction in the plane of the polyester-based film may be 390 kgf/mm² or less, 380 kgf/mm² or less, 350 kgf/mm² or less, 300 kgf/mm² or less, or 280 kgf/mm² or less, and may be 150 kgf/mm² to 400 kgf/mm², 170 kgf/mm² to 380 kgf/mm², 200 kgf/mm² to 350 kgf/mm², 220 kgf/mm² to 300 kgf/mm², or 240 kgf/mm² to 280 kgf/mm².

In addition, the modulus in a second direction perpendicular to the first direction of the polyester-based film may be 535 kgf/mm² or less, 500 kgf/mm² or less, 450 kgf/mm² or less, 400 kgf/mm² or less, 380 kgf/mm² or less, 350 kgf/mm² or less, or 330 kgf/mm² or less, and may be 200 kgf/mm² to 550 kgf/mm², 200 kgf/mm² to 500 kgf/mm², 200 kgf/mm² to 450 kgf/mm², 220 kgf/mm² to 380 kgf/mm², 220 kgf/mm² to 350 kgf/mm², 240 kgf/mm² to 330 kgf/mm², or 260 kgf/mm² to 330 kgf/mm².

As the modulus in the first direction and that in the second direction satisfy the above ranges, respectively, durability in terms of thermal resistance, cold resistance, and chemical resistance is excellent.

In this specification, the first direction may be the transverse direction (TD) or the longitudinal direction (MD). Specifically, the first direction may be the longitudinal direction (MD), and the second direction perpendicular to the first direction may be the transverse direction (TD).

In addition, the polyester-based film may have a ratio of the tensile strength in a first direction in the plane of the film to the tensile strength in a second direction perpendicular to the first direction of 0.8 to 1:1. For example, the ratio of the tensile strength in a first direction in the plane to the tensile strength in a second direction perpendicular to the first direction of the polyester-based film may be 0.81 to 1:1, 0.8 to 0.95:1, or 0.82 to 0.94:1. As the ratio of the tensile strength in a first direction to that in a second direction satisfies the above range, durability in terms of thermal resistance and cold resistance is excellent.

The polyester-based film may have a tensile strength in a first direction in the plane of 14 kgf/mm² or more. For example, the tensile strength in a first direction in the plane of the polyester-based film may be 14.1 kgf/mm² or more, 14.2 kgf/mm² or more, or 14.3 kgf/mm² or more, and may be 14 kgf/mm² to 20 kgf/mm², 14 kgf/mm² to 18 kgf/mm², 14.2 kgf/mm² to 16 kgf/mm², or 14.3 kgf/mm² to 15.8 kgf/mm².

The polyester-based film may have a tensile strength in a second direction perpendicular to the first direction in the plane of 14 kgf/mm² or more. For example, the tensile strength in a second direction of the polyester-based film may be 14.5 kgf/mm² or more, 15 kgf/mm² or more, 16 kgf/mm² or more, or 16.5 kgf/mm² or more, and may be 14 kgf/mm² to 20 kgf/mm², 14.5 kgf/mm² to 20 kgf/mm², 15 kgf/mm² to 20 kgf/mm², 16 kgf/mm² to 20 kgf/mm², 16.5 kgf/mm² to 20 kgf/mm², 16.5 kgf/mm² to 19 kgf/mm², 16.5 kgf/mm² to 18.5 kgf/mm², or 17 kgf/mm² to 18 kgf/mm².

The polyester-based film may have an elongation retention rate of 70% or more. Specifically, when the polyester-based film is subjected to the PCT (pressure cooker test; 121° C., 1.4 atm, RH 100%) for 72 hours, the elongation retention rate may be 71% or more, 72% or more, 80% or more, 85% or more, 90% or more, 93% or more, or 95% or more. As the elongation retention rate satisfies the above range, durability in terms of thermal resistance and cold resistance is excellent.

The elongation retention rate is calculated based on the elongation at break measured according to ASTM-D882 (1997). Specifically, the elongation at break is measured 5 times in each of the first and second directions of the polyester-based film at a spacing between chucks of 50 mm and a tensile speed of 300 m/minute before and after the PCT, and the average value thereof is obtained. The elongation retention rate is calculated according to the following Equation A.

$$\\ \begin{matrix}Elongation retention rate = \frac{Elongation at break after PCT treatment}{Elongation at break before PCT treatment} \times 100 & [ Equation A ]\end{matrix}$$

The polyester-based film may have a glass transition temperature (Tg) of 100° C. or higher as measured by dynamic mechanical analysis (DMA). For example, the glass transition temperature (Tg) of the polyester-based film as measured by dynamic mechanical analysis may be 103° C. or higher, 110° C. or higher, 115° C. or higher, 120° C. or higher, 160° C. or lower, or 150° C. or lower, and may be 100° C. to 160° C., 105° C. to 155° C., 110° C. to 150° C., 115° C. to 160° C., 115° C. to 150° C., 115° C. to 140° C., 120° C. to 160° C., 120° C. to 150° C., or 115° C. to 140° C.

In addition, the polyester-based film may have a glass transition temperature (Tg) of 85° C. or higher as measured by differential scanning calorimetry (DSC). For example, the glass transition temperature (Tg) of the polyester-based film as measured by differential scanning calorimetry may be 86° C. or higher or 88° C. or higher, and may be 85° C. to 150° C., 85° C. to 130° C., 88° C. to 120° C., or 88° C. to 115° C.

The polyester-based film may have a melting point (Tm) of 250° C. or higher as measured by differential scanning calorimetry (DSC). For example, the melting point of the polyester-based film as measured by differential scanning calorimetry may be 253° C. or higher, 255° C. or higher, or 260° C. or higher, and may be 250° C. to 300° C., 255° C. to 295° C., 255° C. to 290° C., 260° C. to 285° C., or 263° C. to 285° C.

In addition, the polyester-based film may have an intrinsic viscosity (IV) of 0.6 dl/g or more. For example, the intrinsic viscosity (IV) of the polyester-based film may be 0.62 dl/g or more, 0.65 dl/g or more, 0.68 dl/g or more, 0.7 dl/g or more, or 0.75 dl/g or more.

The polyester-based film may have a heat shrinkage rate of 3% or less in a first direction in the plane upon thermal treatment at a temperature of 150° C. for 30 minutes. For example, the heat shrinkage rate of the polyester-based film in a first direction in the plane upon thermal treatment at a temperature of 150° C. for 30 minutes may be 2.5% or less, 2% or less, 1.5% or less, or 1.2% or less.

In addition, the polyester-based film may have a heat shrinkage rate of 2% or less in a second direction perpendicular to the first direction upon thermal treatment at a temperature of 150° C. for 30 minutes. For example, the heat shrinkage rate of the polyester-based film in a second direction perpendicular to the first direction upon thermal treatment at a temperature of 150° C. for 30 minutes may be 1.5% or less, 1% or less, 0.8% or less, 0.5% or less, or 0.3% or less.

Specifically, the heat shrinkage rate may be obtained by thermally treating the polyester-based film in an oven at 150° C. for 30 minutes and then measuring the length (mm) in each of the first direction and the second direction perpendicular to the first direction at room temperature. More specifically, the heat shrinkage rate in the MD direction and the heat shrinkage rate in the TD direction may be calculated according to the following Equations 2 and 3.

$$\\ \begin{matrix}{T}_{MD} = \frac{( {L}_{MD 1} - {L}_{MD 2} )}{{L}_{MD 1}} \times 100 & [ Equation 2 ]\end{matrix}$$

$$\\ \begin{matrix}{T}_{TD} = \frac{( {L}_{TD 1} - {L}_{TD 2} )}{{L}_{TD 1}} \times 100 & [ Equation 3 ]\end{matrix}$$

In Equations 2 and 3, T_{MD} is the heat shrinkage rate (%) in the MD direction, L_{MD1} is the length in the MD direction of the initial film (mm), L_{MD2} is the length in the MD direction after heat shrinkage (mm), T_{TD} is the heat shrinkage rate (%) in the TD direction, L_{TD1} is the length in the TD direction of the initial film (mm), and L_{TD2} is the length in the TD direction after heat shrinkage (mm).

The polyester-based film may have a thickness of 10 μm to 150 μm. For example, the thickness of the polyester-based film may be 10 μm to 145 μm, 10 μm to 130 μm, 15 μm to 120 μm, 15 μm to 100 μm, 20 μm to 80 μm, or 20 μm to 60 μm.

Process for Preparing a Polyester-Based Film

The process for preparing a polyester-based film according to another embodiment comprises melt-extruding a copolymerized polyester-based resin in which a diol and a dicarboxylic acid are copolymerized to prepare an unstretched sheet; stretching the unstretched sheet 2 to 5 times in a first direction at 70° C. to 100° C. and stretching it 2 to 5 times in a second direction perpendicular to the first direction to prepare a stretched sheet; heat-setting the stretched sheet at 200° C. to 260° C.; and relaxing the heat-set sheet to prepare the polyester film, wherein the diol comprises cyclohexanedimethanol or a derivative thereof, the dicarboxylic acid comprises 70% by mole to 99% by mole of terephthalic acid and 1% by mole to 30% by mole of isophthalic acid, and the moisture absorption rate of the polyester-based film according to the above Equation 1 is 0.25% or less.

The process for preparing a polyester-based film can provide a polyester-based film excellent in all of the flexibility, adhesion, thermal resistance, durability, and hydrolysis resistance by controlling the sequence of stretching and relaxation steps, temperature, stretching ratios, and relaxation rate.

First, a Polyester-Based Resin in which a Diol and a Dicarboxylic Acid have been Copolymerized is Melt-Extruded to Form an Unstretched Sheet.

Details on the copolymerized polyester-based resin are as described above.

In addition, the copolymerized polyester-based resin may be in the form of chips. Specifically, a mixture of the diol component and the dicarboxylic acid component is reacted at 260° C. to 320° C., 270° C. to 310° C., or 270° C. to 295° C. for 2 hours to 8 hours, 3 hours to 7 hours, or 4 hours to 7 hours to prepare a copolymerized polyester-based resin in the form of chips.

The copolymerized polyester-based resin may be melt-extruded through a T-die and then cooled to obtain an unstretched sheet.

The melt-extrusion step may be carried out at a temperature of Tm+5° C. to Tm+70° C., Tm+5° C. to Tm+50° C., or Tm+7° C. to Tm+35° C. The cooling step may be carried out at a temperature of Tg−120° C. to Tg+20° C., Tg−110° C. to Tg+10° C., Tg−105° C. to Tg−30° C., Tg−105° C. to Tg−50° C., Tg−105° C. to Tg−65° C., or Tg−105° C. to Tg−80° C.

For example, the melt-extrusion temperature may be 260° C. to 320° C., 270° C. to 310° C., or 270° C. to 295° C., and the cooling temperature may be −20° C. to 100° C., 0° C. to 90° C., 5° C. to 75° C., 10° C. to 60° C., 10° C. to 50° C., or 15° C. to 45° C. As the melt-extrusion temperature satisfies the above range, the viscosity of the extrudate may be properly maintained and controlled while the melting of the copolymerized polyester-based resin is carried out smoothly.

Thereafter, the Unstretched Sheet May be Stretched 2 Times to 5 Times in a First Direction at 70° C. to 100° C. and Stretched 2 Times to 5 Times in a Second Direction Perpendicular to the First Direction to Prepare a Stretched Sheet.

Specifically, the unstretched sheet is preheated while it is conveyed at a speed of 10 m/minute to 110 m/minute, 20 m/minute to 90 m/minute, or 20 m/minute to 70 m/minute, and then first stretched in a first direction.

The preheating step may be carried out at 70° C. to 120° C. for 0.01 to 1 minute. For example, the preheating temperature may be 72° C. to 120° C., 75° C. to 115° C., or 80° C. to 100° C., and the preheating time may be 0.02 to 1 minute, 0.05 to 0.5 minute, or 0.08 to 0.2 minute.

In addition, the first stretching may be carried out at a temperature of 75° C. to 100° C. at a stretching ratio of 2 times to 5 times. For example, the first stretching may be carried out at a temperature of 75° C. to 98° C., 75° C. to 95° C., 80° C. to 95° C., or 85° C. to 93° C. at a stretching ratio of 2 times to 4.8 times, 2 times to 4.5 times, 2.5 times to 4 times, 2.5 times to 3.5 times, or 2.8 times to 3.3 times. If the temperature and the stretching ratio of the first stretching satisfy the above ranges, it is possible to enhance the thermal resistance and hydrolysis resistance.

According to another embodiment, before the first stretching, heat may be applied using a far-infrared heater (R/H) at a position of 40 mm to 150 mm from the preheated unstretched sheet. For example, the far-infrared heater may be located at a distance of 55 mm to 150 mm, 70 mm to 150 mm, 70 mm to 100 mm, 85 mm to 120 mm, or 100 mm to 150 mm away from one side of the preheated unstretched sheet. The far-infrared heater may apply heat at 650° C. to 800° C., 700° C. to 800° C., or 730° C. to 780° C.

In addition, after the first stretching, a second stretching is carried out in a second direction perpendicular to the first direction. The second stretching may be carried out at a temperature higher than the preheating temperature by 10° C. to 30° C. at a stretching ratio of 2 times to 5 times. For example, the second stretching may be carried out at a temperature of 100° C. to 140° C., 110° C. to 130° C., or 120° C. to 130° C. at a stretching ratio of 2 times to 4.8 times, 2.5 times to 4.5 times, 2.5 times to 4 times, or 2.8 times to 4 times.

The ratio (d1/d2) of the stretching ratio in a first direction (d1) to the stretching ratio in a second direction (d2) may be 0.5 to 1. For example, the ratio (d1/d2) of the stretching ratio in a first direction (d1) to the stretching ratio in a second direction (d2) may be 0.5 to 0.9 or 0.6 to 0.8. As the ratio of the stretching ratio in a first direction to that in a second direction satisfies the above range, it is possible to enhance the hydrolysis resistance and low hygroscopicity.

In addition, a coating step may be further carried out before the second stretching. Specifically, the coating step may be a step capable of imparting functionality such as antistatic properties to the polyester-based film and carried out by in-line coating, but it is not limited thereto.

Thereafter, the Stretched Sheet is Heat-Set at 200° C. to 260° C.

Specifically, the heat setting may be annealing and carried out at 200° C. to 260° C. for 0.01 minute to 1 minute. For example, the heat setting step may be carried out at a temperature of 205° C. to 260° C., 210° C. to 255° C., 225° C. to 250° C., 238° C. to 248° C., or 238° C. to 245° C. for 0.01 minute to 0.8 minute, 0.05 minute to 0.5 minute, 0.08 minute to 0.2 minute, or 0.08 minute to 0.15 minute. As the temperature and time of the heat setting step satisfy the above ranges, the heat shrinkage rate of the polyester film can be easily adjusted.

Finally, the Heat-Set Sheet is Relaxed to Prepare a Polyester-Based Film.

Specifically, the heat-set sheet may be relaxed in a first direction or in a second direction perpendicular to the first direction.

For example, if the heat-set sheet is relaxed in a first direction or in a second direction perpendicular to the first direction, the relaxation step may be carried out at a temperature of 100° C. to 180° C. or 110° C. to 175° C. at a relaxation rate of 0.5% to 5%, 0.8% to 4%, 0.8% to 3.5%, or 0.8% to 3.2%.

Alternatively, the heat-set sheet may be first relaxed in a first direction and then second relaxed in a second direction, or the heat-set sheet may be first relaxed in a second direction and then second relaxed in a first direction. For example, the heat-set sheet may be first relaxed in the TD direction and then second relaxed in the MD direction.

Specifically, the relaxation step may be carried out as first relaxation at a relaxation rate of 1% to 10% in a second direction and second relaxation at a relaxation rate of 0.5% to less than 2% in a first direction. Specifically, if the heat-set sheet is first relaxed and then second relaxed, the first relaxation step may be carried out at a temperature of 150° C. to 200° C. at a relaxation rate of 1% to 10%, and the second relaxation step may be carried out at a temperature of 110° C. to 190° C. at a relaxation rate of 0.5% to less than 2%.

For example, the first relaxation step may be carried out at a temperature of 150° C. to 190° C., 155° C. to 200° C., 160° C. to 180° C., or 165° C. to 175° C. at a relaxation rate of 1% to 9.5%, 1% to 9%, 1.5% to 8%, 1.5% to 7%, 2% to 6%, or 2% to 5%, and the second relaxation step may be carried out at a temperature of 110° C. to 185° C., 110° C. to 180° C., 110° C. to 170° C., 115° C. to 150° C., 115° C. to 140° C., or 115° C. to 130° C. at a relaxation rate of 0.5% to less than 2%, 0.5% to 1.95%, 0.7% to 1.8%, 0.85% to 1.65%, 0.9% to 1.6%, 0.9% to 1.4%, or 0.95% to 1.2%.

If the temperatures and relaxation rates of the first relaxation step and second relaxation step satisfy the above ranges, it is possible to enhance the thermal resistance and hydrolysis resistance.

In addition, the ratio of the first relaxation rate to the second relaxation rate may be 1:0.1 to 1.0. For example, the ratio of the first relaxation rate to the second relaxation rate may be 1:0.1 to 0.9, 1:0.1 to 0.8, 1:0.2 to 0.7, or 1:0.25 to 0.65. If the ratio of the first relaxation rate to the second relaxation rate satisfies the above range, it is possible to maximize the thermal resistance and hydrolysis resistance.

Specifically, the second relaxation step may be carried out in two or more sections, and the second relaxation rate may be the sum of the relaxation rates of each section. For example, if the second relaxation step is carried out in 4 sections, and the relaxation rates of the 4 sections are sequentially 0%, 0.5%, 0.5%, and 1%, respectively, the second relaxation rate is 2%. As the second relaxation step is carried out in several sections as described above, the relaxation rate can be more easily controlled, so that it is possible to maximize the thermal resistance and hydrolysis resistance.

The conveying speed of the film in the second relaxation step may be slower than the conveying speed of the film in the first relaxation step by 1% to 10%. For example, the conveying speed of the film in the second relaxation step may be slower than the conveying speed of the film in the first relaxation step by 2% to 10% or 2% to 8%.

Membrane Electrode Assembly

The membrane electrode assembly according to still another embodiment comprises an electrolyte membrane; and a sub-gasket surrounding the distal ends of one side or both sides of the electrolyte membrane, wherein sub-gasket comprises a copolymerized polyester-based resin in which a diol and a dicarboxylic acid are copolymerized, the diol comprises cyclohexanedimethanol or a derivative thereof, the dicarboxylic acid comprises 70% by mole to 99% by mole of terephthalic acid and 1% by mole to 30% by mole of isophthalic acid, and the moisture absorption rate according to the above Equation 1 is 0.25% or less.

Specifically, the sub-gasket may comprise a first sub-gasket film and a second sub-gasket film.

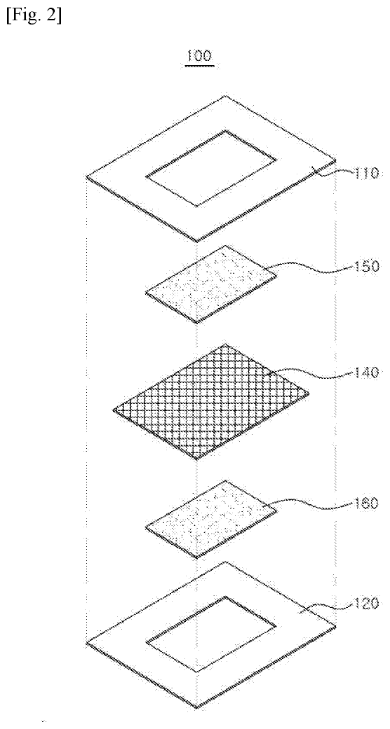

FIG. 2 shows a perspective view of a membrane electrode assembly according to an embodiment. Specifically, it exemplifies a membrane electrode assembly (100) composed of an electrolyte membrane (140), a first electrode (150) and a second electrode (160) disposed on both sides of the electrolyte membrane, a first sub-gasket film (110) disposed on the upper part of the first electrode, and a second sub-gasket film (120) disposed on the lower part of the second electrode.

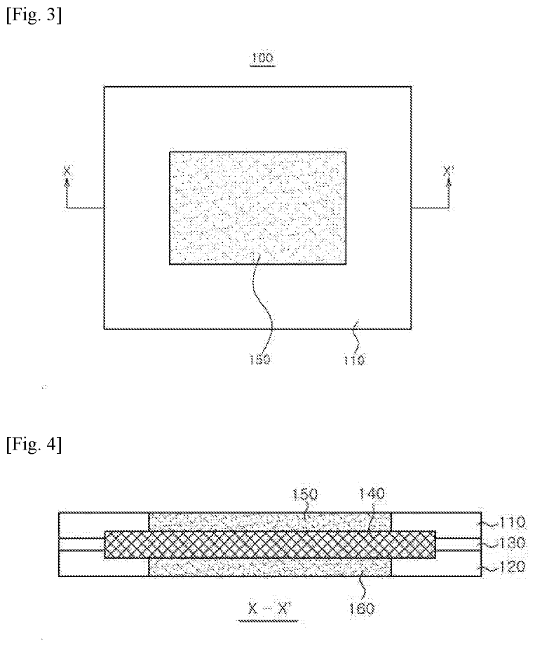

FIG. 3 shows a top view of a membrane electrode assembly according to an embodiment. Specifically, FIG. 3 shows a top view of the membrane electrode assembly of FIG. 2, in which a first electrode (150) is located in the central part, and a first sub-gasket film (110) is disposed to surround the first electrode.

FIG. 4 is a cross-sectional view of the membrane electrode assembly of FIG. 3 taken along line X-X′. Specifically, FIG. 4 exemplifies a membrane electrode assembly composed of an electrolyte membrane (140) located in the central part, a first electrode (150) and a second electrode (160) disposed on the upper side and lower side of the electrolyte membrane, respectively, a first sub-gasket film (110) disposed on the upper part of both distal ends of the electrolyte membrane, a second sub-gasket film (120) disposed on the lower part of both distal ends of the electrolyte membrane, and an adhesive layer (130) interposed between the first sub-gasket film (110) and the second sub-gasket film (120).

As the membrane electrode assembly according to an embodiment comprises a sub-gasket surrounding the distal ends of one side or both sides of the electrolyte membrane, it is possible to enhance the stability and reliability of the fuel cell. Specifically, as the sub-gasket surrounds and seals the distal ends of one side or both sides of the electrolyte membrane, it is possible to effectively prevent the fuel or the like from leaking out or being mixed with other substances such as air. In addition, it is possible to prevent the performance of the membrane electrode assembly from being deteriorated due to the hygroscopicity of the electrolyte membrane.

The first sub-gasket film may be the polyester-based film described above. Specifically, the first sub-gasket film and the second sub-gasket film may be the polyester-based film described above, and the components and contents thereof may be the same as, or different from, each other.

In addition, the ratio of the thickness of the first sub-gasket film to the thickness of the second sub-gasket film may be 0.5 to 1.5:1. For example, the ratio of the thickness of the first sub-gasket film to the thickness of the second sub-gasket film may be 0.5 to 1.4:1, 0.7 to 1.2:1, or 0.9 to 1.1:1.

The adhesive layer may comprise at least one selected from the group consisting of an acrylic-based resin, a silicone-based resin, and a urethane-based resin. Specifically, the adhesive layer may be formed by coating a resin composition comprising at least one selected from the group consisting of an acrylic-based resin, a silicone-based resin, and a urethane-based resin, but it is not limited thereto.

In addition, the adhesive layer may have a thickness of 5 μm to 80 μm. For example, the thickness of the adhesive layer may be 5 μm to 75 μm, 7 μm to 70 μm, 10 μm to 65 μm, 15 μm to 50 μm, 15 μm to 45 μm, or 15 μm to 30 μm.

The sub-gasket may have a tensile strength of 105 MPa or more. For example, the tensile strength of the sub-gasket may be 108 MPa or more, 110 MPa or more, 115 MPa or more, or 120 MPa or more.

The electrolyte membrane may serve as a diaphragm in order to transport a fuel or the like or in order for the same not to be directly mixed with air. The electrolyte membrane may comprise at least one selected from the group consisting of a perfluorosulfonic acid-based resin, a polyimide-based resin, a polyethersulfone-based resin, a polyphenylene oxide-based resin, a polyethylene naphthalate-based resin, and a polyester-based resin.

In addition, the first electrode and the second electrode may face each other and may have the same area as each other. Specifically, the first electrode and the second electrode may be positioned to face each other in the central part of the electrolyte membrane, and the first electrode and the second electrode each may be in contact with 60% to 90% or 65% to 95% of the area of one side of the electrolyte membrane.

The first electrode may be an anode or a cathode, and the second electrode may be a cathode or an anode. Specifically, the first electrode may be an anode, and the second electrode may be a cathode.

In addition, the membrane electrode assembly may further comprise a catalyst layer and a gas diffusion layer capable of enhancing its performance. The catalyst layer and the gas diffusion layer are not particularly limited as long as they are used in a membrane electrode assembly in the art.

### Mode for the Invention

Hereinafter, the present invention will be described in more detail with reference to the following examples. However, these examples are set forth to illustrate the present invention, and the scope of the present invention is not limited thereto.

### Example

Preparation of a Copolymerized Polyester-Based Resin

### Preparation Example 1-1

100% by mole of cyclohexanedimethanol (CHDM) as a diol component and 96% by mole of terephthalic acid (TPA) and 4% by mole of isophthalic acid (IPA) as a dicarboxylic acid component were mixed and reacted at 285° C. for 6 hours to prepare a copolymerized polyester-based resin in the form of chips.

### Preparation Examples 1-2 to 1-6

Copolymerized polyester-based resins in the form of chips were prepared in the same manner as in Preparation Example 1-1, except that the components and contents were changed as shown in Table 1 below.

TABLE 1

| | Diol | | Dicarboxylic acid | | |
|---|---|---|---|---|---|
| | EG | CHDM | NDC | TPA | IPA |
| | (% by | (% by | (% by | (% by | (% by |
| | mole) | mole) | mole) | mole) | mole) |
| Preparation | — | 100 | — | 96 | 4 |
| Example 1-1 | | | | | |
| Preparation | — | 100 | — | 88 | 12 |
| Example 1-2 | | | | | |
| Preparation | — | 100 | — | 88 | 12 |
| Example 1-3 | | | | | |
| Preparation | 100 | — | — | 100 | — |
| Example 1-4 | | | | | |
| Preparation | 100 | — | 100 | — | — |
| Example 1-5 | | | | | |
| Preparation | — | 100 | — | 100 | — |
| Example 1-6 | | | | | |

* EG: ethylene glycol; NDC: naphthalene dicarboxylic acid

Preparation of a Polyester-Based Film

### Example 1

The copolymerized polyester-based resin prepared in Preparation Example 1-1 was melt-extruded through an extruder at 290° C. and then cooled on a casting roll at 25° C. to prepare an unstretched sheet.

The unstretched sheet was preheated to 92° C. while it was conveyed at a speed of 30 m/minute. While the preheated unstretched sheet was conveyed at a speed of 30 m/minute, heat of 750° C. was applied with a far-infrared heater (R/H) at a position of 80 mm from the preheated unstretched sheet.

Thereafter, the unstretched sheet was first stretched 3.1 times in the MD direction at 90° C., second stretched 3.9 times in the TD direction at 125° C., and then heat-set at 240° C. for 0.1 minute.

Thereafter, the heat-set sheet was first relaxed at a relaxation rate of 3% in the TD direction at a temperature of 170° C. and a conveying speed of 50 m/minute and second relaxed at a relaxation rate of 1.0% in the MD direction at a temperature of 120° C. and a conveying speed of 50 m/minute to prepare a polyester-based film having a thickness of 25 μm. The second relaxation in the MD direction was carried out in 4 sections, and the relaxation rates of the 4 sections were 0%, 0%, 0.5%, and 0.5%, respectively.

### Example 2 and Comparative Examples 1 to 4

Polyester-based films were prepared in the same manner as in Example 1, except that the copolymerized polyester-based resins of Preparation Examples 1-2 to 1-6 were each used instead of that of Preparation Example 1-1 under the process conditions shown in Table 2 below.

Here, in Comparative Example 4 in which the copolymerized polyester-based resin of Preparation Examples 1-6 was used, it was impossible to form a film, failing to prepare a film.

TABLE 2

| | | Stretching | | | Heat | Relaxation | |
|---|---|---|---|---|---|---|---|
| | | ratio | | | setting | rate | |
| | | MD | TD | R/H | Temp. | MD | TD |
| | Resin | (times) | (times) | (° C.) | (° C.) | (%) | (%) |
| Ex. 1 | Prep. Ex 1-1 | 3.1 | 3.9 | 750 | 240 | 1.0 | 3 |
| Ex. 2 | Prep. Ex 1-2 | 3.1 | 3.9 | 750 | 240 | 1.5 | 3 |
| C. Ex. 1 | Prep. Ex 1-3 | 3.0 | 3.9 | 750 | 240 | 2.0 | 3 |
| C. Ex. 2 | Prep. Ex 1-4 | 3.1 | 3.9 | 750 | 240 | — | 3 |
| C. Ex. 3 | Prep. Ex 1-5 | 3.1 | 3.9 | 750 | 240 | — | 3 |

| | | |
|---|---|---|
| C. Ex. 4 | Prep. Ex 1-6 | N/A |

### Test Example

### Test Example 1: Measurement of Glass Transition Temperature (Tg) and Melting Point (Tm)

The films (10 mg) of Examples 1 and 2 and Comparative Examples 1 to 3 were each measured for the glass transition temperature (Tg) and the melting point (Tm) using a differential scanning calorimeter (Q2000, manufacturer: TA).

### Test Example 2: Intrinsic Viscosity (IV)

The films (10 mg) of Examples 1 and 2 and Comparative Examples 1 to 3 were each dissolved in ortho-chlorophenol at 100° C., and the relative viscosity was measured with an Ostwald viscometer at 35° C. in a thermostatic bath by measuring the time for the sample to drop. The relative viscosity thus measured was converted to intrinsic viscosity (IV) based on the relative viscosity to intrinsic viscosity conversion table. Here, the value rounded off to the third decimal place is shown in Table 3 below.

### Test Example 3: Hygroscopicity

The films of Examples 1 and 2 and Comparative Examples 1 to 3 were each dried in an oven at 50° C. for 24 hours, and the weight (A) was measured. After the dried film under the above conditions was left at a temperature of 25° C. and a humidity of 100% RH for 24 hours, its weight (B) was measured. The moisture absorption rate was calculated according to Equation 1 below.

$$\\ \begin{matrix}Moisture absorption rate = \frac{( B - A )}{A} \times 100 & [ Equation 1 ]\end{matrix}$$

In Equation 1, A is the weight (g) of the film measured after the film is dried in an oven at 50° C. for 24 hours, and B is the weight (g) of the film measured after the dried film under the above conditions is left at a temperature of 25° C. and a humidity of 100% RH for 24 hours.

### Test Example 4: Elongation Retention Rate

The films of Examples 1 and 2 and Comparative Examples 1 to 3 were each subjected to the PCT (pressure cooker test; 121° C. 1.4 atm, RH 100%) for 72 hours, and the elongation retention rate was then measured.

Specifically, the elongation at break was measured 5 times in each of the first and second directions of the polyester-based film at a spacing between chucks of 50 mm and a tensile speed of 300 m/min before and after the PCT in accordance with ASTM-D882 (1997), and the average value thereof is obtained. The elongation retention rate is calculated according to the following Equation A.

$$\\ \begin{matrix}Elongation retention rate = \frac{Elongation at break after PCT treatment}{Elongation at break before PCT treatment} \times 100 & [ Equation A ]\end{matrix}$$

### Test Example 5: Modulus

The films of Examples 1 and 2 and Comparative Examples 1 to 3 were each measured for the modulus in the MD and TD directions in accordance with KS B 5521.

### Test Example 6: Heat Shrinkage Rate

The films of Examples 1 and 2 and Comparative Examples 1 to 3 were each cut to 100 mm in length and 100 mm in width, which was thermally treated in an oven at 150° C. for 30 minutes. The length (mm) of each in the TD direction and the MD direction was then measured at room temperature. The heat shrinkage rate was calculated using Equations 2 and 3 below.

$$\\ \begin{matrix}{T}_{MD} = \frac{( {L}_{MD 1} - {L}_{MD 2} )}{{L}_{MD 1}} \times 100 & [ Equation 2 ]\end{matrix}$$

$$\\ \begin{matrix}{T}_{TD} = \frac{( {L}_{TD 1} - {L}_{TD 2} )}{{L}_{TD 1}} \times 100 & [ Equation 3 ]\end{matrix}$$

In Equations 2 and 3, T_{MD} is the heat shrinkage rate (%) in the MD direction, L_{MD1} is the length in the MD direction of the initial film (mm), L_{MD2} is the length in the MD direction after heat shrinkage (mm), TTD is the heat shrinkage rate (%) in the TD direction, L_{TD1} is the length in the TD direction of the initial film (mm), and L_{TD2} is the length in the TD direction after heat shrinkage (mm).

### Test Example 7: Tensile Strength

The films of Examples 1 and 2 and Comparative Examples 1 to 3 were each cut to 100 mm in length and 15 mm in width, which was mounted to a universal tester of INSTRON (4206-001, manufacturer: UTM) at a spacing between chucks of 50 mm in accordance with ASTM-D882. Testing was performed at a tensile speed of 500 mm/minutes, and the tensile strength was measured with a program installed in the device.

TABLE 3

| | | | Intrinsic | Moisture | Elongation |
|---|---|---|---|---|---|
| | Tg | Tm | viscosity | absorption rate | retention rate |
| | (° C.) | (° C.) | (dl/g) | (%) | (%) |
| Ex. 1 | 91 | 282 | 0.75 | 0.10 | 96 |
| Ex. 2 | 89 | 265 | 0.78 | 0.09 | 72 |
| C. Ex. 1 | 89 | 265 | 0.78 | 0.11 | 72 |
| C. Ex. 2 | 75 | 255 | 0.64 | 0.34 | 54 |
| C. Ex. 3 | 120 | 266 | 0.70 | 0.30 | 72 |

TABLE 4

| | Modulus | | Heat shrinkage | | Tensile strength | |
|---|---|---|---|---|---|---|
| | (kgf/mm²) | | rate (%) | | (kgf/mm²) | |
| | MD | TD | MD | TD | MD | TD |
| Ex. 1 | 260 | 300 | 0.9 | 0.3 | 14.4 | 17.5 |
| Ex. 2 | 265 | 312 | 1.1 | 0.15 | 15.6 | 16.7 |
| C. Ex. 1 | 251 | 298 | 1.0 | 0.2 | 12.8 | 17.1 |
| C. Ex. 2 | 430 | 570 | 1.2 | 0.5 | 15.1 | 26.1 |
| C. Ex. 3 | 530 | 600 | 0.6 | 0.2 | 17.1 | 20.7 |

As shown in Tables 3 and 4 above, the polyester-based films of Examples 1 and 2 had excellent hydrolysis resistance and durability as compared with the films of Comparative Example 1 to 3.

Specifically, as the polyester-based films of Examples 1 and 2 satisfied preferred ranges of intrinsic viscosity, hygroscopicity, elongation retention rate, modulus, heat shrinkage rate, and tensile strength, they were excellent in durability in terms of thermal resistance. As they were excellent in hydrolysis resistance, they had significantly low hygroscopicity.

1. A polyester-based film, which comprises a copolymerized polyester-based resin in which a diol and a dicarboxylic acid are copolymerized, wherein the diol comprises cyclohexanedimethanol or a derivative thereof, the dicarboxylic acid comprises 70% by mole to 99% by mole of terephthalic acid and 1% by mole to 30% by mole of isophthalic acid, and a moisture absorption rate according to following Equation 1 is 0.25% or less:
$$\\ \begin{matrix}Moisture absorption rate = \frac{( B - A )}{A} \times 100 & [ Equation 1 ]\end{matrix}$$
in Equation 1, A is a weight (g) of the polyester-based film measured after the polyester-based film is dried in an oven at 50° C. for 24 hours, and B is a weight (g) of the polyester-based film measured after the dried polyester-based film under the above conditions is left at a temperature of 25° C. and a humidity of 100% RH for 24 hours.

2. The polyester-based film of claim 1, wherein the polyester-based film is a film for a sub-gasket of a fuel cell.

3. The polyester-based film of claim 1, wherein the diol comprises cyclohexanedimethanol or a derivative thereof in an amount of 70% by mole or more.

4. The polyester-based film of claim 1, wherein the polyester-based film has a modulus in a first direction in the plane of the film of 400 kgf/mm² or less and a modulus in a second direction perpendicular to the first direction of 550 kgf/mm² or less.

5. The polyester-based film of claim 1, wherein the polyester-based film has a ratio of tensile strength in a first direction in the plane of the film to tensile strength in a second direction perpendicular to the first direction of 0.8 to 1:1.

6. The polyester-based film of claim 1, wherein, when the polyester-based film is subjected to the PCT (pressure cooker test; 121° C., 1.4 atm, RH 100%) for 72 hours, the elongation retention rate is 70% or more.

7. A process for preparing a polyester film, which comprises:
melt-extruding a copolymerized polyester-based resin in which a diol and a dicarboxylic acid are copolymerized to prepare an unstretched sheet;
stretching the unstretched sheet 2 to 5 times in a first direction at 70° C. to 100° C. and stretching it 2 to 5 times in a second direction perpendicular to the first direction to prepare a stretched sheet;
heat-setting the stretched sheet at 200° C. to 260° C.; and
relaxing the heat-set sheet to prepare the polyester film,
wherein the diol comprises cyclohexanedimethanol or a derivative thereof, the dicarboxylic acid comprises 70% by mole to 99% by mole of terephthalic acid and 1% by mole to 30% by mole of isophthalic acid, and a moisture absorption rate of the polyester-based film according to following Equation 1 is 0.25% or less:
$$\\ \begin{matrix}Moisture absorption rate = \frac{( B - A )}{A} \times 100 & [ Equation 1 ]\end{matrix}$$
in Equation 1, A is a weight (g) of the polyester-based film measured after the polyester-based film is dried in an oven at 50° C. for 24 hours, and B is a weight (g) of the polyester-based film measured after the dried polyester-based film under the above conditions is left at a temperature of 25° C. and a humidity of 100% RH for 24 hours.

8. The process for preparing a polyester film of claim 7, wherein a ratio (d1/d2) of the stretching ratio in the first direction (d1) to the stretching ratio in the second direction (d2) is 0.5 to 1, and the relaxation step is carried out as first relaxation at a relaxation rate of 1% to 10% in the second direction and second relaxation at a relaxation rate of 0.5% to less than 2% in the first direction.

9. A membrane electrode assembly, which comprises an electrolyte membrane; and a sub-gasket surrounding the distal ends of one side or both sides of the electrolyte membrane, wherein the sub-gasket comprises a copolymerized polyester-based resin in which a diol and a dicarboxylic acid are copolymerized, the diol comprises cyclohexanedimethanol or a derivative thereof, the dicarboxylic acid comprises 70% by mole to 99% by mole of terephthalic acid and 1% by mole to 30% by mole of isophthalic acid, and a moisture absorption rate according to following Equation 1 is 0.25% or less:
$$\\ \begin{matrix}Moisture absorption rate = \frac{( B - A )}{A} \times 100 & [ Equation 1 ]\end{matrix}$$
in Equation 1, A is a weight (g) of the polyester-based film measured after the polyester-based film is dried in an oven at 50° C. for 24 hours, and B is a weight (g) of the polyester-based film measured after the dried polyester-based film under the above conditions is left at a temperature of 25° C. and a humidity of 100% RH for 24 hours.

10. The membrane electrode assembly of claim 9, wherein the sub-gasket has a tensile strength of 105 MPa or more.
